(19) United States
(12) Patent Application Publication
(10) Pub. No.: US 2025/0342320 A1
(43) Pub. Date: Nov. 6, 2025

(54) CATEGORIZATION OF NATURAL LANGUAGE GENERATOR AGENTS AND GUIDED SELECTION TECHNIQUE

(71) Applicant: SAP SE, Walldorf (DE)

(72) Inventor: Tim Keller, Mannheim (DE)

(73) Assignee: SAP SE, Walldorf (DE)

(21) Appl. No.: 18/652,520

(22) Filed: May 1, 2024

(51) Int. Cl. G06F 40/40

(52) U.S. Cl. CPC G06F 40/40

(57) ABSTRACT

Techniques and solutions are provided for improving the performance and capabilities of natural language generators. A natural language generator is progressively presented with proper subsets of a set of capabilities. Some of the capabilities correspond to discrete agents, whose execution can be triggered by a selection of a discrete agent by the natural language generator. Other capabilities correspond to categories that are used to organize capabilities corresponding to discrete agents or other categories. The natural language generator can progressively select capabilities until a capability corresponding to a discrete agent is selected. The discrete agent can then be executed, and execution results can be provided to the natural language generator. The present disclosure also provides for computer-implemented categorization of capabilities.

### FIELD

The present disclosure generally relates to agents that can be used to expand the functionality of natural language generators.

### BACKGROUND

Natural language generators, such as large language models, are a revolutionary technology rapidly integrating into the daily lives of millions of people. These models, often referred to as “chatbots,” given that for many “consumer” uses they use a dialog interface, possess the remarkable ability to process and comprehend natural human language input. They can then generate responses in the same fluid human language, making interactions with them highly accessible. The user-friendly nature of these models, which facilitate effortless input and deliver understandable responses, combined with their remarkable accuracy, contributes to their exceptional power and case of adoption.

There is a desire to expand the use of natural language generators beyond their already significant utility. In some cases, this can involve improving the operation of natural language generators so that they can process more complex tasks, including those that may include information the natural language generator may not be “aware of” as part of its base training. For example, in order to understand a prompt, the natural language generator might need to process particular portions of the prompt, reflecting information not immediately known to the natural language generator, so that the overall prompt can be understood.

Further, it is desirable to increase the functionality of natural language generators that can be used in processing prompts or generating responses. For example, natural language generators have the capability of performing actions such as analyzing image or text files or performing Internet searches. Natural language generators have also been provided with functionality such as image generation, so that responses can go beyond text-based responses. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and solutions are provided for improving the performance and capabilities of natural language generators. A natural language generator is progressively presented with proper subsets of a set of capabilities. Some of the capabilities correspond to discrete agents, whose execution can be triggered by a selection of a discrete agent by the natural language generator. Other capabilities correspond to categories that are used to organize capabilities corresponding to discrete agents or other categories. The natural language generator can progressively select capabilities until a capability corresponding to a discrete agent is selected. The discrete agent can then be executed, and execution results can be provided to the natural language generator. The present disclosure also provides for computer-implemented categorization of capabilities.

In one aspect, the present disclosure provides a process of progressively submitting subsets of a set of capabilities to a natural language generator. Data representing a hierarchically structured collection of a plurality of capabilities is received. A first proper subset of the plurality of capabilities are, or represent, discrete agents whose execution can be called in response to a request from a natural language generator and a second proper subset of the plurality of capabilities correspond to a subcategory of a higher-level capability.

Capabilities of a first hierarchical level of the hierarchically structured collection are submitted to a natural language generator. From the natural language generator, a selection of a capability of the second proper subset is received. Capabilities of a second hierarchical level are submitted to the natural language generator. A selection of a capability of the second hierarchical level is received from the natural language generator. The capability of the second hierarchical level is a capability of the first proper subset. The discrete agent corresponding to the capability of the second hierarchical level is executed. Execution results of the executing the agent are returned to the natural language generator.

In another aspect, the present disclosure provides a process of progressively submitting subsets of a set of capabilities to a natural language generator. Data representing a hierarchically structured collection of a plurality of capabilities is received. A first proper subset of the plurality of capabilities are, or represent, discrete agents whose execution can be called in response to a request from a natural language generator and a second proper subset of the plurality of capabilities correspond to a category comprising one or more discrete agents of the first proper subset.

Capabilities of a first hierarchical level of the hierarchically structured collection are submitted to a natural language generator. A selection of a capability of the second proper subset is received from the natural language generator. Capabilities of a second hierarchical level are submitted to the natural language generator. A selection of a capability of the second hierarchical level is received from the natural language generator. The capability of the second hierarchical level is a capability of the first proper subset. The discrete agent corresponding to the capability of the second hierarchical level is executed. Execution results of the executing the agent are returned to the natural language generator.

In a further aspect, the present disclosure provides a process of a natural language generator selecting a capability for execution after being progressively presented with sets of capabilities. A natural language generator receives a first plurality of capabilities. Capabilities of the first plurality of capabilities are a first proper subset of a plurality of capabilities. Capabilities of the first proper subset provide respective capability categories. The natural language generator selects a capability of the first proper subset. The natural language generator receives capabilities of a second proper subset of the plurality of capabilities. A given capability of the second proper subset is, or represents, a discrete agent whose execution can be called in response to a request from the natural language generator. The natural language generator selects a capability of the second proper subset.

The present disclosure also includes computing systems and tangible, non-transitory computer-readable storage media configured to carry out, or includes instructions for carrying out an above-described method. As described herein, a variety of other features and advantages can be incorporated into the technologies as desired.

### BRIEF DESCRIPTION OF THE DRAWINGS

FIG. 1 is a diagram illustrating a ReACT prompting technique for natural language generators, where a natural language generator performs a reasoning step following by an action generated from the reasoning step.

FIG. 2 is a diagram illustrating operations during operation of a natural language generator using an AutoGPT technique, where a natural language generator generates output that is provided back to the natural language generator in a prompt.

FIG. 3 is a diagram illustrating a disclosed process where a natural language generator is provided with information regarding capabilities it has in a hierarchical manner, such that a more limited number of capabilities is provided to the natural language generator in a single communication, while large number of capabilities can be defined, since the natural language generator can proceed down the hierarchy until a suitable capability is identified, where such capability is, or is associated with, an agent that can be called by or on behalf of the natural language generator.

FIG. 4A provides an example list of agents that can be used with a natural language generator, while FIGS. 4B-4D illustrate how these agents, and capabilities used to categorize agents, can differ depending on a threshold maximum number of capabilities for one or more levels of the hierarchy.

FIG. 5 provides example flowcharts for a process of categorizing capabilities and for a process of progressively providing a natural language generator with portions of hierarchically organized set of capabilities until a capability is selected that corresponds to an agent that can be executed to provide information to the natural language generator.

FIG. 6 provides example code providing agent subclasses of a base agent class that can be executed to perform operations for a natural language generator and which can be hierarchically organized using disclosed techniques.

FIGS. 7A-7M provide example code implementing techniques of the present disclosure, including techniques for generating a repository of agents and categorizing agents.

FIG. 8A is a flowchart of an example process of progressively submitting subsets of a set of capabilities to a natural language generator.

FIG. 8B is a flowchart of another example process of progressively submitting subsets of a set of capabilities to a natural language generator.

FIG. 8C is a flowchart of an example process of a natural language generator selecting a capability for execution after being progressively presented with sets of capabilities.

FIG. 9 is a diagram of an example computing system in which some described embodiments can be implemented.

FIG. 10 is an example cloud computing environment that can be used in conjunction with the technologies described herein.

### DETAILED DESCRIPTION

### Example 1)—Overview

Natural language generators, such as large language models, are a revolutionary technology rapidly integrating into the daily lives of millions of people. These models, often referred to as “chatbots,” given that for many “consumer” uses they use a dialog interface, possess the remarkable ability to process and comprehend natural human language input. They can then generate responses in the same fluid human language, making interactions with them highly accessible. The user-friendly nature of these models, which facilitate effortless input and deliver understandable responses, combined with their remarkable accuracy, contributes to their exceptional power and case of adoption.

There is a desire to expand the use of natural language generators beyond their already significant utility. In some cases, this can involve improving the operation of natural language generators so that they can process more complex tasks, including those that may include information the natural language generator may not be “aware of” as part of its base training. For example, in order to understand a prompt, the natural language generator might need to process particular portions of the prompt, reflecting information not immediately known to the natural language generator, so that the overall prompt can be understood.

Further, it is desirable to increase the functionality of natural language generators that can be used in processing prompts or generating responses. For example, natural language generators have the capability of performing actions such as analyzing image or text files or performing Internet searches. Natural language generators have also been provided with functionality such as image generation, so that responses can go beyond text-based responses. Accordingly, room for improvement exists.

One technique that has been used to improve the capabilities of natural language generators to process more complex prompts is ReACT (Reasoning and Acting) prompting. In this approach, rather than simply asking a natural language generator to perform a task, the natural language generator is prompted to perform reasoning about how a task might be performed. After the reasoning, the natural language generator can perform actions based on the reasoning. For example, a prompt may require certain information before it can be processed, and so a reasoning step might involve a natural language generator determining a plan for responding to the prompt, which can include determining what information it needs and how to obtain such information. The natural language generator can then execute the tasks it identified.

Another approach to modifying natural language generators, or at least how they are used, to respond to more complex tasks is AutoGPT. Like ReACT prompting, the natural language generator can define tasks and subtasks to achieve a particular goal. However, AutoGPT allows natural language generators to generate and execute prompts on their own-self prompting. This process can be iterative, such as where tasks or subtasks to achieve a goal can be modified. For example, a natural language generator may change its strategy for achieving a goal based on particular information obtained from executing a task. Compared with ReACT prompting, AutoGPT typically is more autonomously performed by the natural language generator, whereas ReACT prompting often involves human guidance.

As described, some recent advancements in natural language generators focus on providing tools for natural language generators to help them better complete tasks or complete new types of tasks. One issue that can arise is that a natural language generator can get “overwhelmed” if too many tools are provided. The natural language generator may fail to identify a tool to complete task, or may use the wrong tool (for example in response to a suboptimal reasoning operation because too many tools were identified for its use).

The present disclosure provides techniques that allow for a larger number of tools to be made available to a natural language generator while maintaining or improving the ability of the natural language generator to select the correct tool. In particular, the ability of natural language generators to select a correct tool may drop as a function of the number of tools that are available.

Disclosed techniques involve liming a number of tools that a natural language generator considers at one time. For example, if a number of tools exceeds a threshold, categories can be developed (which represent capabilities), and tools (representing more specific/actionable capabilities) can be classified into these categories. This categorization process can be continued for additional hierarchical levels until tools are categorized and distributed in a way that the natural language generator can make an accurate selection.

For example, assume 100 tools are made available to the natural language generator, and a threshold is set that no category should have more than 5 tools. As a first step, it is determined whether the tools themselves are under the threshold. If not, a number of capability categories are defined, up to the threshold, and tools are assigned to those categories. It is then determined, for each category, whether the number of tools exceeds a threshold. If not, no further categorization is needed. If so, the process of creating capability categories and assigning tools to them can continue until the number of tools in all categories satisfies the threshold.

When the natural language generator determines how it may complete a task, it may first look at the general capability categories and select the capability that it determines is most likely relevant to the task that is to be performed. If the capability is a category, the natural language generator can then “look within” the category and determine which capabilities in the category might be suitable for its use. This process can continue until the natural language generator selects a capability that corresponds to a tool/is “actionable.”

In addition to expanding the number of tools that are available to a natural language generator, disclosed techniques can improve the accuracy of tool selection, and the generation of tasks to achieve a goal. That is, the natural language generator may define a task at least in part on the tools that it has available. Stated another way, the available tools constrain, to a degree, a natural language generator's options for generating and processing tasks. Having the correct tools available, and organized in a way that can be effectively analyzed by the natural language generator, helps the natural language generator develop an effective strategy.

While tool categorization can be performed manually, disclosed techniques provide for having categorization performed by a natural language generator. It can be impracticable for humans to categorize large numbers of tools, and the definition of categories and assignment of tools to categories can be subjective and subject to errors. Further, the present disclosure provides a framework for creating and registering tools, referred to as “agents” for use. To help ensure that category limits are maintained, and the most useful categories and category assignments created, all or a portion of an agent repository can be recategorized when a new agent is registered.

Although the present disclosure provides a detailed example of using a natural language generator to perform clustering and cluster naming for capabilities/agents, other techniques can be used. For clustering, techniques such as K-means, hierarchical, or density-based clustering (DBSCAN) can be used. Clustering can be performed, in some cases, on mathematical representations of the semantic meaning of capabilities/agents, such as by generating embeddings (such as semantic, word, sentence, or context embeddings) using techniques such as Word2Vec, Doc2Vec, GloVe, FastText, Universal Sentence Encoder, BERT (bidirectional encoder representations from transformers), or Sentence Transformers. Deep learning techniques can also be used for clustering, such as using autoencoders, deep embedded clustering, self-organizing maps, graph neural networks, or deep clustering networks. Cluster names can be generated using techniques such as keyword extraction (such as using Term Frequency-Inverse Document Frequency or TextRank), Sequence to Sequence models, transformer models (such as using BERT), or Generative Adversarial Networks.

Thus, disclosed techniques help expand the functionality of natural language generators. As natural language generators can be computationally expensive to use, disclosed techniques can reduce computing resource use by helping to ensure that a natural language generator creates an efficient strategy for achieving a goal/responding to a prompt.

### Example 2)—Example ReACT Prompting

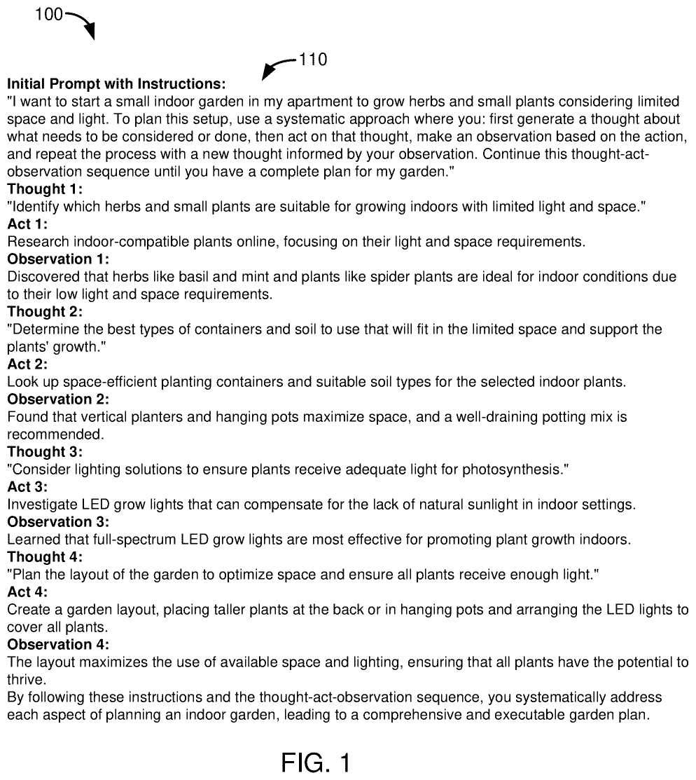

FIG. 1 illustrates a prompt and hypothetical “reasoning” flow 100 for a natural language generator using ReACT prompting. ReACT prompting can, at least in some cases, be performed by natural language generators, such as large language models, without making changes to the natural language generator itself. For example, the techniques can be used with the consumer versions of CHATGPT 3.5 and CHATGPT 4.0 (both of OPENIAI).

An initial prompt 110 provides a task request to a natural language generator. However, the initial prompt also provides instructions about how the task should be performed. The initial prompt 110 instructs the natural language generator to first generate thoughts on what needs to be performed to accomplish the task, act on the thought, generate an observation after performing the action, and then to generate new thoughts and continue the process until the task is complete. The remainder of the flow 100 illustrates the thoughts, acts, and observations generated by the natural language generator in response to the initial prompt 110.

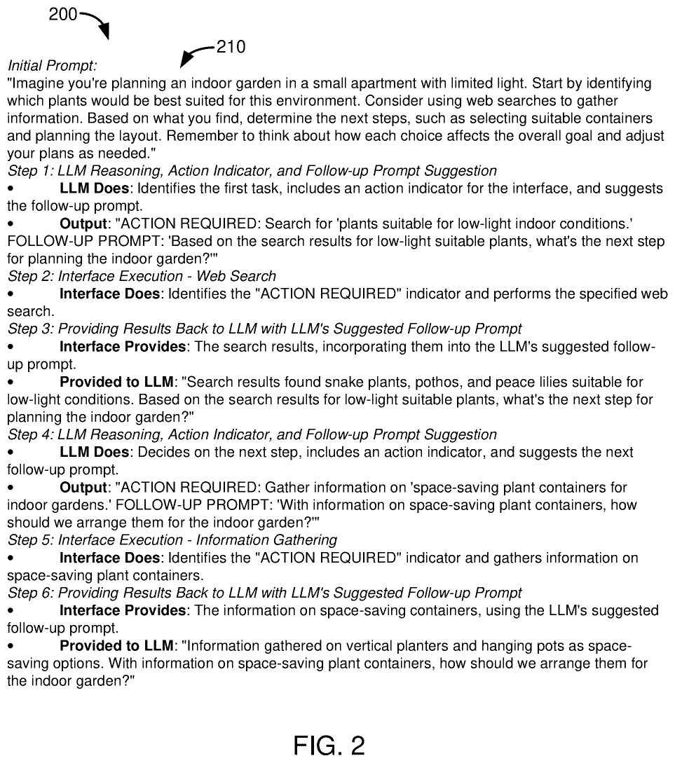

FIG. 2 illustrates a prompt and hypothetical “reasoning” flow 200 using AutoGPT. In this case, it can be seen that an initial prompt 210 with the task does not explicitly specify how the natural language generator should go about performing a task. However, the initial prompt 210 does provide hints to the natural language generator that may help trigger reflection by the natural language generator and breaking tasks into subtasks. The initial prompt 210 also provides an indication of particular tools, in this case web searching, that can be used by the natural language generator in accomplishing the task.

Note that the reasoning flow 200 indicates particular “flags” in output generated by the natural language generator that can be used by an interface in implementing Auto-GPT functionality, including self-prompting. For example, “ACTION REQUIRED” can be a keyword for the interface to call supporting functionality, such as performing a web search, and “FOLLOW-UP PROMPT” can trigger the interface to submit the corresponding information in the natural language generator's response as a new prompt to be processed by the natural language generator.

### Example 3—Computing Environment Registering and Categorizing Agents and Progressive Capability Presentation

In the reasoning flow 200 of FIG. 2, consider a scenario where many tools are available to a natural language generator. Including all of the tools available to the natural language generator might exceed the single-prompt context window. Even if it does not, the availability of many tools may limit the ability of the natural language generator to select the correct tool. In addition, because the available tools might influence how a natural language generator might decide to accomplish a goal, having too many tools to consider can cause the natural language generator to generate an ineffective strategy.

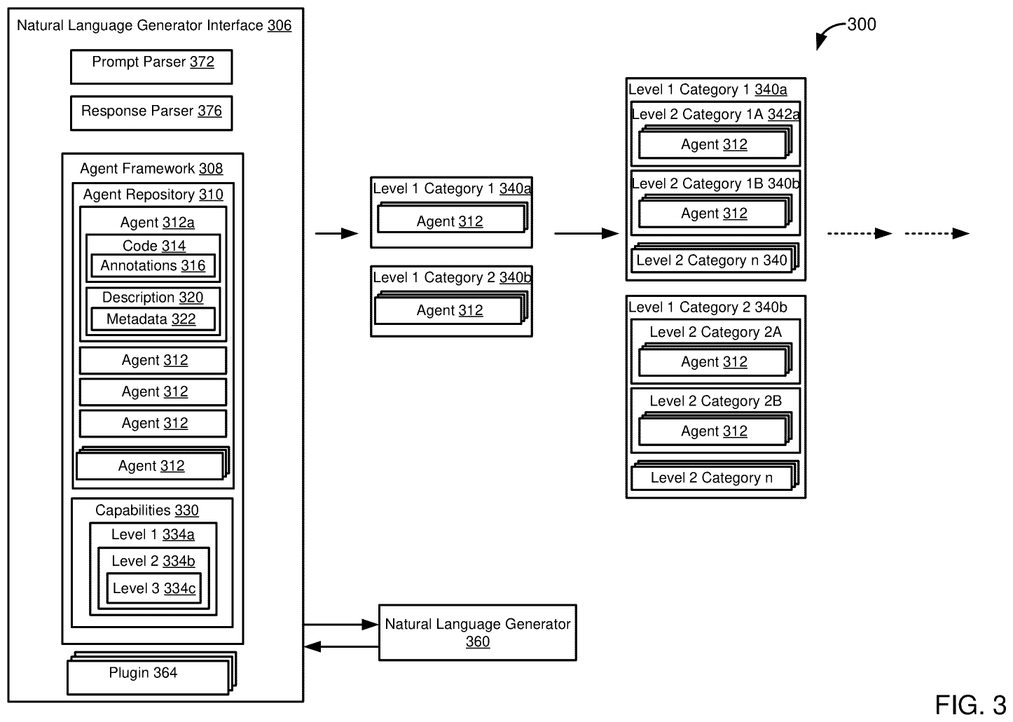

FIG. 3 provides a general overview of a computing environment 300 according to the present disclosure that can address these issues. A natural language processor interface 306 can be used in processing requests with a natural language generator 360. Agents 312 can be registered in an agent repository 310 of an agent framework 308 of the interface 306. The agents 312 provided particular functionality, “tools,” that can supplement the functionality of the natural language generator 360.

As shown for agent 312a, a given agent 312 can include code 314, or other information or instructions, that can be used to implement particular functionality of the agent. The code 314 can include annotations 316, where the annotations can assist in determining what capabilities are provided by an agent 312, as well as information about input that the agent accepts or output that is provided by the agent.

Typically, an agent 312 also includes descriptive information 320. The descriptive information 320 can include metadata 322, where the metadata can include information describing the functionality provided by an agent.

A set of capabilities 330 are defined based on information for the agents 312, including the annotations 316 or the metadata 322. The capabilities 330 are organized hierarchically. As shown, the capabilities 330 are shown as having three hierarchical levels 334a, 334b, 334c. However, disclosed techniques can be used with two hierarchical levels or more than three hierarchical levels. As will be further described, a number of hierarchical levels can depend on the number of agents 312 to be included in the capabilities 330 and settings that define the organization of the capabilities, such as a maximum number of capabilities or agents to include in a particular level, or a maximum number of levels. That is, even with the same set of capabilities 330/agents 312, the levels 334 generated, their depth, their description, and the agents 312 assigned to the levels can differ depending on the threshold that is set.

While in some cases the threshold is the same for all levels 334, if desired, different thresholds can be set for different level depths or different levels. Some levels 334 may not be subject to a threshold. Different use cases, even with the same set of agents 312, can have different thresholds. In a further implementation, a maximum level depth can be set, and the thresholds defined using that constraint.

In practice, a natural language generator 360 can be provided with a set of capabilities at a particular level of the capabilities. Levels of the hierarchy can be thought as of “folders” in a file system, where at least “leaf” levels of the hierarchy have capabilities that are mapped to agents 312/represent actionable capabilities. From initial set of hierarchies, the natural language generator 360 can select a capability that it believes best matches its requirements for accomplishing a task. If the selected capability is mapped to an agent 312, the agent can be called. If the capability corresponds to another level/folder, the natural language generator 360 can be provided with the list of capabilities at the lower level. This process continues until a capability mapped to an agent 312 is selected.

Capability and agent information can be implemented and stored in various ways. For example, in some cases capabilities can refer to categories into which agents are classified, while agents are classified into these categories. In other cases, capabilities can refer to agents 312 or the categories which are used to organize and describe the agents. In the case where capabilities refers to both agents 312 and categories, a definition of a capability can indicate whether the capability corresponds to an agent. In the case where agents 312 and capabilities are more explicitly differentiated, description information for agents can be provided to assist in classifying the agents and for assisting a natural language generator in selecting an appropriate agent.

Capability/agent information can be stored in any suitable manner. In some cases, it can be beneficial to store this information in a database, such as a relational database, where capability/agent information is stored in one or more database tables, and, if desired, can be incorporated into one or more views. An example table definition for storing agent/configuration information is:

| | | | | | |
|---|---|---|---|---|---|
| Capability | Capability | Parent | Child | Is | Agent |
| Name | Description | Capability | Capability | Agent? | Path |

Where capability name provides a name or other identifier of a capability, capability description provides descriptive information regarding the nature of the capabilities (such as describing what actions are performed/data is provided, etc.), parent and child capabilities are used to track the hierarchical structure of capabilities, “is agent” indicates whether the capability is/corresponds to an agent, and agent path provide a location that can be accessed to execute an agent corresponding to a capability.

Other formats may be used to store agent information, such as using a JSON structure such as (and including capability information for two levels-one being a category and another corresponds to an agent 312):

```
{
  “capabilities”: [
    {
      “id”: “cap1”,
      “name:: “Data Processing”,
      “description”: “Capability of processing data in a variety of formats”,
      “parent capability”: null,
      “child capabilities”: [“cap2”, “cap3”],
      “isAgent”: false,
      “agentPath”: null
    },
    {
      “id”: “cap2”,
      “name”: “Data Cleaning”,
      “description”: “Capability of cleaning and normalizing data”,
      “parent capability”: “cap1”,
      “child capabilities”: [ ],
      “isAgent”: true,
      “agentPath”: /path/to/data_cleaning_agent”
    },
  ]
}
```

In some cases, agents 312 are natively coded in the agent framework 308. However, disclosed techniques also provide for registering agents through plugins 364. In a particular example, a base class is defined, and agents can be registered with the agent framework 308 by providing subclasses of the base class. The agent framework 308 can include functionality for scanning for plugins 364. If a new plugin 364 is identified, a function of the plugin can be called by the framework 308 that implements an agent registration process, after which the agents in the plugin are registered as agents 312. While in some cases all of the agents 312 in the agent repository 310 are available for use with any given prompt to the natural language generator, specific use cases can define a particular subset of agents 312 that will be available.

Interactions with the natural language generator 360 can be mediated using a prompt parser 372 or a response parser 376. The prompt parser 372 can, for example, receive a prompt, such as from a particular user, and add descriptions of capabilities that are provided by the agents 312 or a capability category. The natural language generator 360 can select a capability. When the capability corresponds to a category, the response parser 376 can generate or modify a request to the prompt parser 372 to add a new set of capabilities to a prompt to the natural language generator 360. In the event the natural language generator 360 selects an agent 312, or a capability corresponding to an agent, the response parser 376 can call the corresponding agent, including providing argument values provided by the natural language generator 360.

FIG. 3 also illustrates a process for structuring the capabilities 330. All of the capabilities associated with agents 312 are first analyzed for categorization. Assume that two capabilities 340a, 340b, corresponding to capability categories (in other words, they organize other capability categories or agents, but are not agents or directly correspond to agents) are identified for the first level of the hierarchy 334a. It can be determined whether a number of capabilities 344 associated with agents 312 in the capability categories 340a, 340b exceeds a threshold. If so, additional capabilities 342 can be defined at the second level of the hierarchy 334b, where capability 342 is associated with one or more of the capabilities 344, as shown for capabilities 342a, 342b.

The capabilities 342 can again be analyzed to determine if any capabilities exceed a threshold number of agents 312. If so, the process can continue and more capability subcategories can be defined, and capabilities associated with agents assigned to those capabilities until all such capabilities have been assigned to a capability category that satisfies the threshold.

Note that the hierarchy for the capabilities need not be symmetrical. That is, some capability categories may have more subcategories than other, and the depth for different branches of the hierarchy can vary. Similarly, for capability categories that contain capabilities 340 that correspond to agents 312, different capability categories can have differing numbers of such capabilities-they do not need to be evenly distributed.

### Example 4—Example Agent Classification Using Different Threshold Values

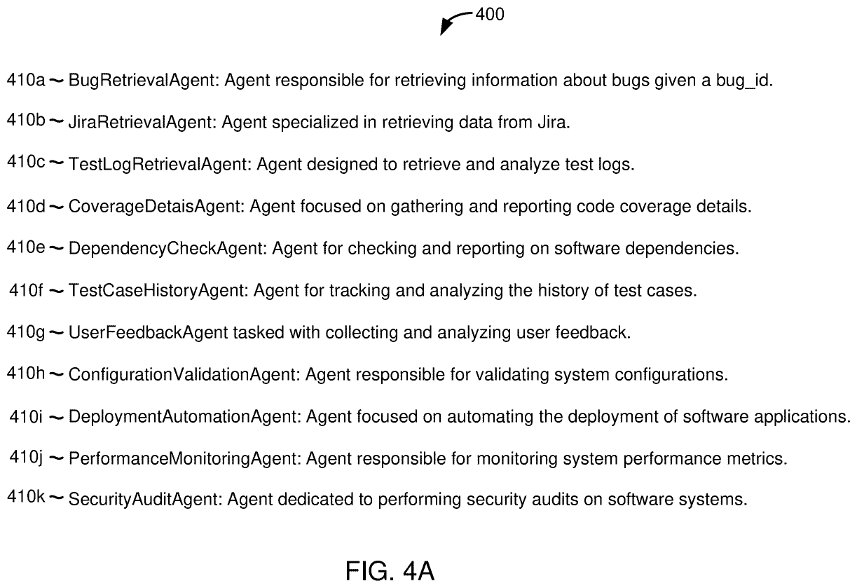

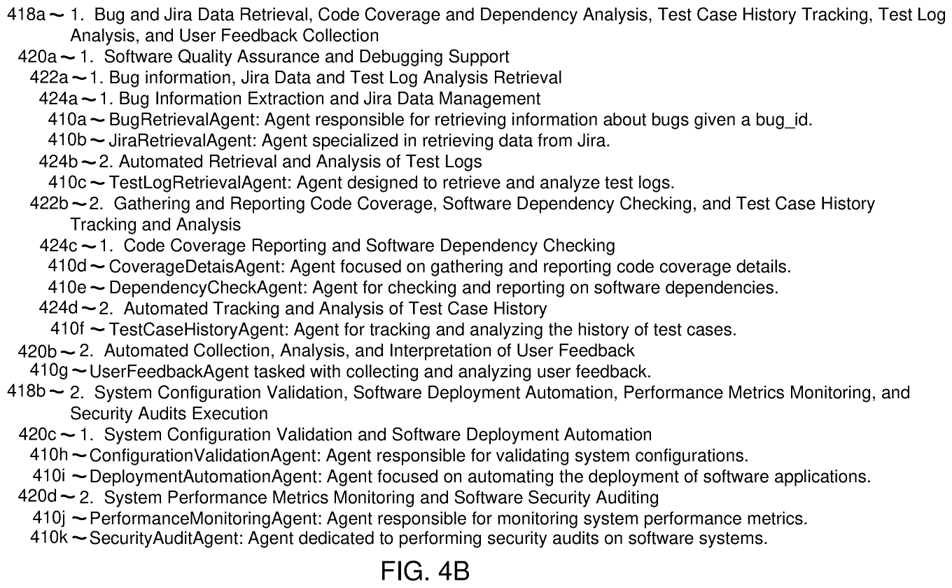

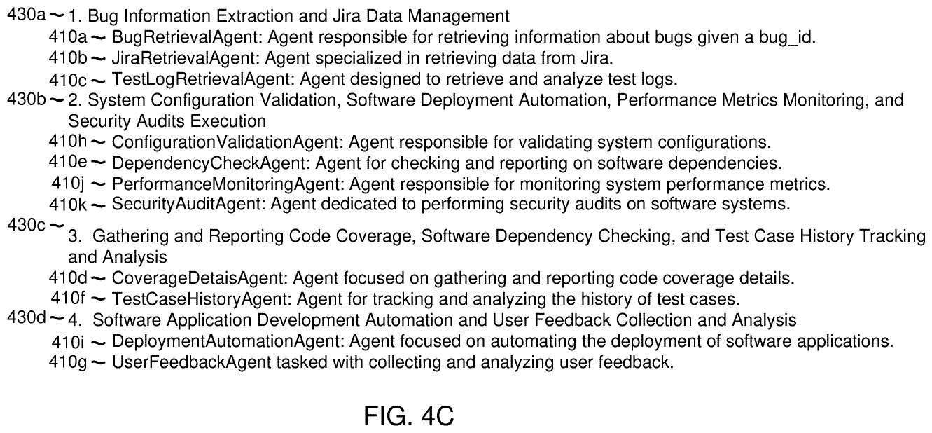

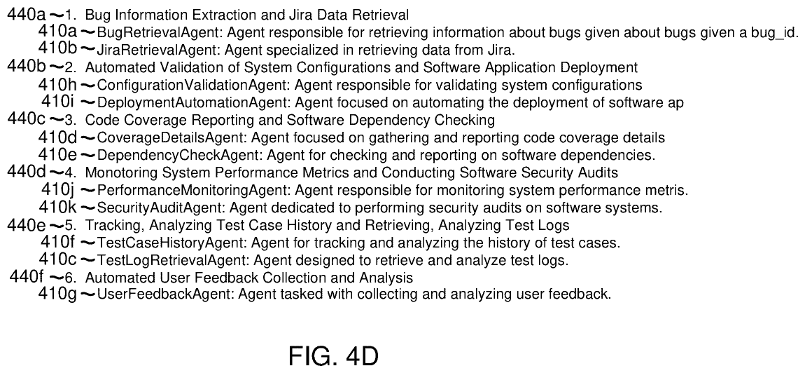

As an example of how agents can be categorized, consider the list 400 of agents 410 (shown as agents 410a-410k) of FIG. 4A. While the size of the list 400 is comparatively small, the same process can be applied to larger lists, including lists that may be too large to be effectively processed by a natural language generator in a single prompt.

A threshold can be defined for a maximum number of agents 410 or subcategories to include in any category, which can influence the structure of the resulting hierarchy. That is, for example if a number of agents in category exceeds the threshold, subcategories, up to the threshold, are created, and agents assigned to those subcategories. Those subcategories are then analyzed, and the process can continue.

FIG. 4B illustrates the list 400 organized using a threshold of 2. That is, any particular category may contain at most two agents or subcategories. The list 400 is analyzed, and, since the 11 agents 410 exceed the threshold of 2, two categories 418a, 418b are defined based on the descriptive information available for the agents 410, and the agents are then assigned to a category 418, 418b.

Taking category 418a as an example, it can be seen that 7 agents were originally assigned to the category, which exceeds the threshold of two. Accordingly, two subcategories 420a, 420b are defined based on the descriptive information for the agents 410 assigned to the category 418a. The agents 410 in subcategory 418a are then assigned to subcategories 420a, 420b.

In this case, 6 agents were assigned to subcategory 420a, while a single agent was assigned to subcategory 420b. Since subcategory 420b satisfies the threshold, it does not need to be further subcategorized. However, since subcategory 420a exceeds the threshold, subcategories 422a, 422b are created, and agents 410 assigned to them. The assignment results in 3 agents 410 being assigned to subcategory 422a and three agents being assigned to subcategory 422b. The subcategories 422a, 422b also exceed the threshold, and so subcategories 424a, 424b are created for subcategory 422a, while subcategories 424c, 424d are created for subcategory 422b. The agents 410 are again assigned to the subcategories, with two agents 410 each being assigned to subcategories 424a, 424c, and a single agent each being assigned to subcategories 424b, 424d. None of the subcategories 424a-424d exceeds the threshold, so the categorization process stops.

For subcategory 418b, 4 agents were originally assigned. Since the threshold is exceeded, subcategories 420c, 420d are created, and the agents distributed. Since each subcategory 420c, 420d includes 2 agents, the threshold is satisfied, and no further categorization is needed.

FIG. 4C illustrates the result of processing the agents 410 in a similar manner as discussed with respect to FIG. 4B, but now using a threshold of 4. Again, starting with 11 agents 410, the threshold is exceeded, and so subcategories 430a, 430b, 430c, 430d are created, and agents assigned to them. None of the subcategories 430a-430d has more than 4 agents, and so no further categorization is needed.

FIG. 4D, using a threshold of 6, is processed similarly as in FIG. 4C, where the threshold is initially exceeded, and subcategories 440a-440f defined. The agents 410 are assigned to the subcategories 440a-440f and, since no subcategory exceeds the threshold, no further categorization is needed.

Now, with reference back to FIG. 4B, consider how a natural language generator can process the structured capabilities to locate an agent 410 that can be used in performing a task. Assume that a task the natural language generator is to perform could be assisted by checking for software dependencies.

Initially, the natural language generator would be presented with the information for the subcategories 418a, 418b, as:
You are able to perform tasks relating to (1) Bug and Jira Data Retrieval, Code Coverage and Dependency Analysis, Test Case History Tracking, Test Log Analysis, and User Feedback Collection; and (2) System Configuration Validation, Software Deployment Automation, Performance Metrics Monitoring, and Security Audits Execution.

Based on these descriptions, the natural language generator may determine that subcategory 418a has the capabilities that are most relevant to its task, and selects this subcategory. Again, note that the natural language generator may determine how to perform a task based on the availability capabilities, and so selecting subcategory 418a can be based on the natural language generator determining that it describes functionality that would be helpful in completing its task.

Selection of the subcategory 418a can then result in presenting information to the natural language generator regarding subcategories 420a, 420b, such as:
You are able to perform tasks relating to (1) Software Quality Assurance and Debugging Support; and (2) Automated Collection, Analysis, and Interpretation of User Feedback.

Based on this, the natural language generator may select subcategory 420a as most relevant (for example, since dependency analysis can be used in both quality assurance and in debugging). Information for subcategories 422a, 422b are then presented to the natural language generator, such:
You are able to perform tasks related to (1) Bug Information, Jira Data, Test Log Analysis Retrieval; and (2) Gathering and Reporting Code Coverage, Software Dependency Checking, and Test Case History Tracking and analysis.

The natural language generator determines that subcategory 422b is most relevant, and in response to it being selected, can be presented with information regarding subcategories 424c, 424d, such as:
You are able to perform tasks related to (1) Code Coverage Reporting and Dependency Checking; and (2) Automated Tracking and Analysis of Test Case History.

The natural language generator would select subcategory 424c as most relevant, and so the contents of that subcategory would be presented to the natural language generator, such as:
You are able to perform tasks related to (1) CodeDataCoverageDetailsAgent: Agent focused on gathering and reporting code coverage details; and (2) DependencyCheckAgent: Agent for checking and reporting on software dependencies.

The natural language generator can the select the agent 410e, and generate a response that triggers the use of such agent.

### Example 5—Example Process for Categorizing and Presenting Capabilities

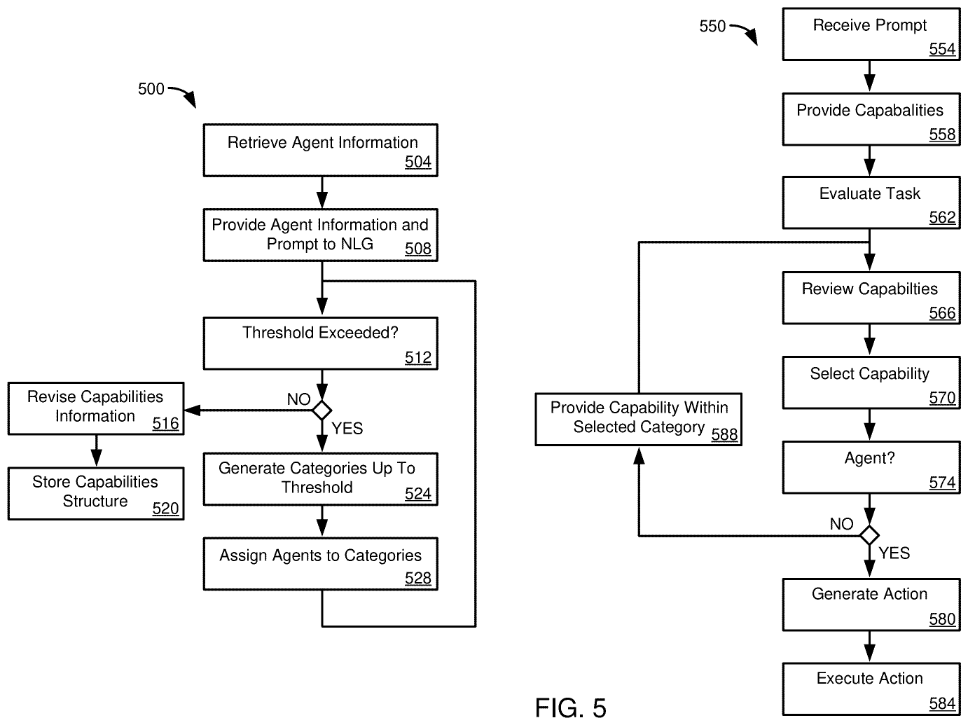

FIG. 5 provides a flowchart of a process for categorizing agents using a natural language generator. At 504, agent information is retrieved, such as from the agent repository 310 of FIG. 3. The agent information and a prompt are provided to a natural language generator at 508. The prompt includes instructions about how the natural language generator should categorize agents, including any thresholds that should be used.

At 512, the natural language generator determines whether the number of agents in a category (including in a general, uncategorized list of agents provided at 508) exceeds a threshold. If not, a capability structure is saved at 520, such as a capability structure as described with respect to FIG. 3 (the capabilities 330). Optionally, at 516, the natural language generator can review and revise the description of categories in the capability structure, or names or descriptive information regarding agents.

That is, the natural language generator can revise this information such that it provides improved guidance to a natural language generator in reviewing and selecting capabilities. Among other things, revising the information can include analyzing category or agent names or descriptive information with respect to one another, to help ensure that the categories or agents have names or descriptive information that are sufficiently different such that a more determinative selection can be made by the natural language generator. That is, it can be beneficial to reduce potentially ambiguity as to what functionality is provided by various capabilities and agents.

If the threshold is exceeded, at 524, the natural language generator reviews the information for the agents, and optionally other elements of the capability structure (such as the names of other categories in the structure, or agents in such other categories), and generates additional categories (subcategories) up to the threshold. The natural language generator can consider the threshold as well as the information regarding the agents to be assigned in determining categories. For example, as described with respect to FIGS. 4A-4E, broader categories may be defined when a smaller threshold is set, and the available number of categories to create can affect how category boundaries are defined. The natural language generator then assigns the agents to generate the categories at 528. The process 500 then returns to 508.

FIG. 5 also illustrates a flowchart of an example process 550 for a natural language generator to use in selecting a capability, and associated agent, for use in performing a task. A prompt is received at 554. A list of capabilities is provided to the large language model at 558. At 562, the natural language generator evaluates, including generating, a task that will help it respond to the prompt. The natural language generator reviews the capabilities in view of the task at 566, and then at 570 selects a capability that is most likely to be useful in accomplishing the task.

At 574, it is determined if the selected capability corresponds to an agent. If so, an action can be generated using the agent to perform the desired task at 580, and the agent is executed at 584. If the selected capability does not correspond to an agent, at 588, the natural language generator is provided with capabilities within the selected capability (corresponding to a category), and the process 500 can return to 566.

### Example 6—Example Agent Definitions

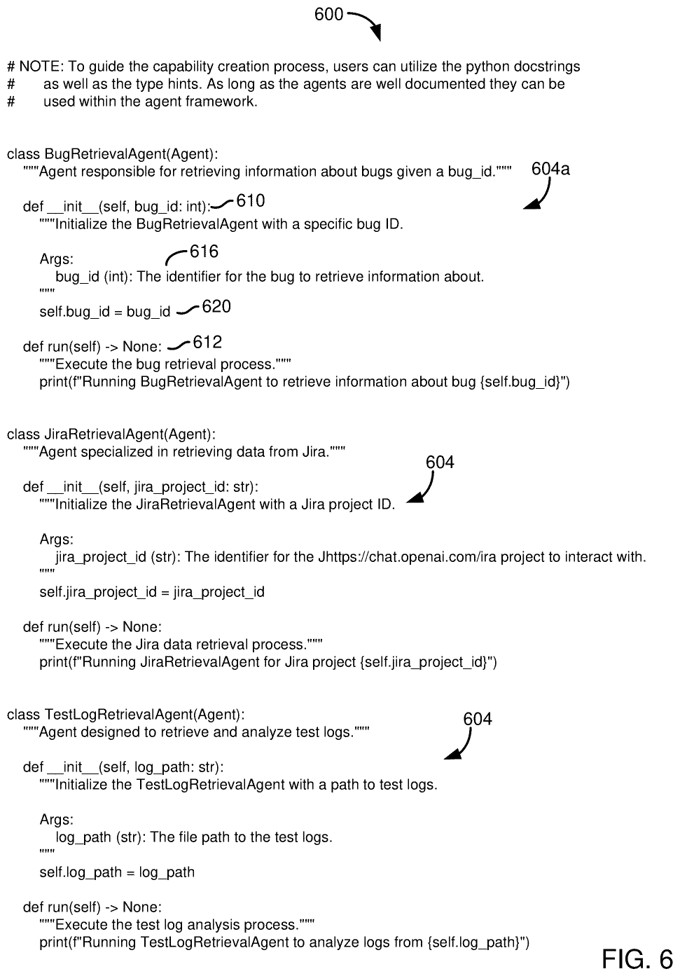

FIG. 6 provides example code 600 for implementing agents according to a particular implementation of disclosed techniques. The agents are provided for example purposes only, and in practice their definitions would include more complete code for performing agent actions.

Agent definitions 604 in the code 600 are defined in the form of classes, where the classes can be derived classes of a base class. For example, an agent framework can be provided to facilitate the development and registration of agents. The base class can represent an interface, where a class that implements the interface can be created when it is desired to add a new agent.

While some of the features of a class that implements an agent may be defined by a base class or interface, other features may be specified with respect for documentation for the interface. For example, agent definition 604a includes a “docstring” that describes the purpose or functionality of the agent. This information can correspond to the metadata 322 of FIG. 3, and can be used in categorizing the agent, and thus also, in at least some cases, selecting the agent by a natural language generator during prompt processing. The information can be provided in another manner, including in a manner that can be more strictly defined or enforced. For example, a base class or interface can define a required data member that stores descriptive information for the agent.

In the code, the general structure of an implementing class requires two functions, an initiation function, such as the initialization function 610 for the agent 604a, and a run function, such as the run function 612. In the case of the initialization function 610, any arguments required by, or useable with, the agent are defined/documented, such as argument 616 of the initialization function 610 of the agent 604a. The initialization function 610 can serve as a “constructor” for an instance of the agent class, and so member variables for the agent can be declared in the initialization function, such as the bug_id variable 620.

### Example 7—Example Agent Management and Classification Code

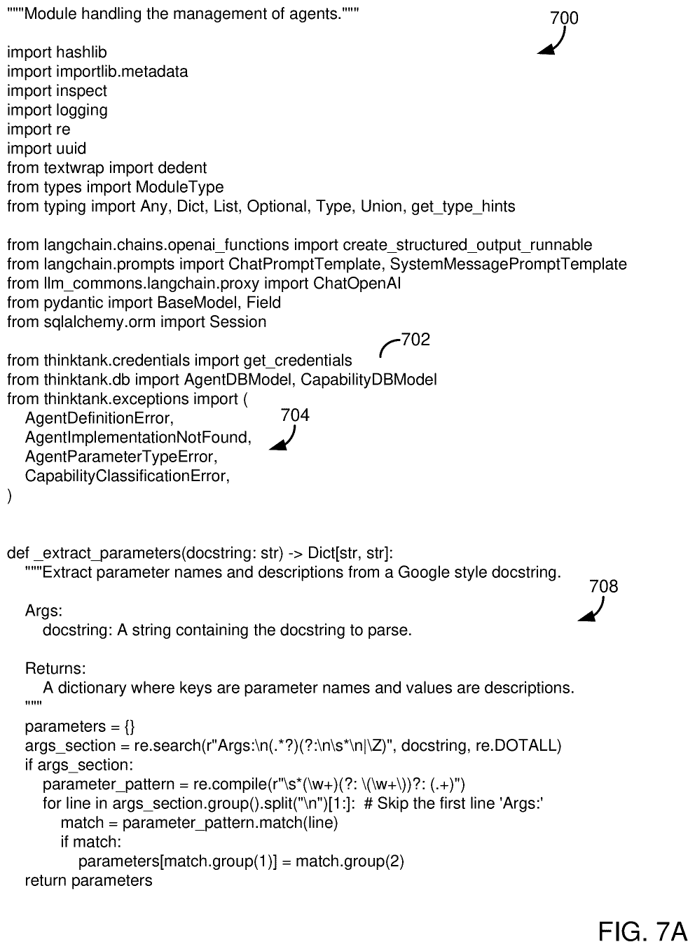

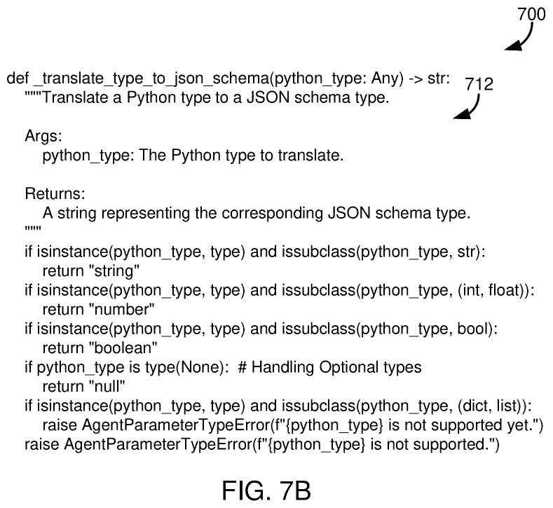

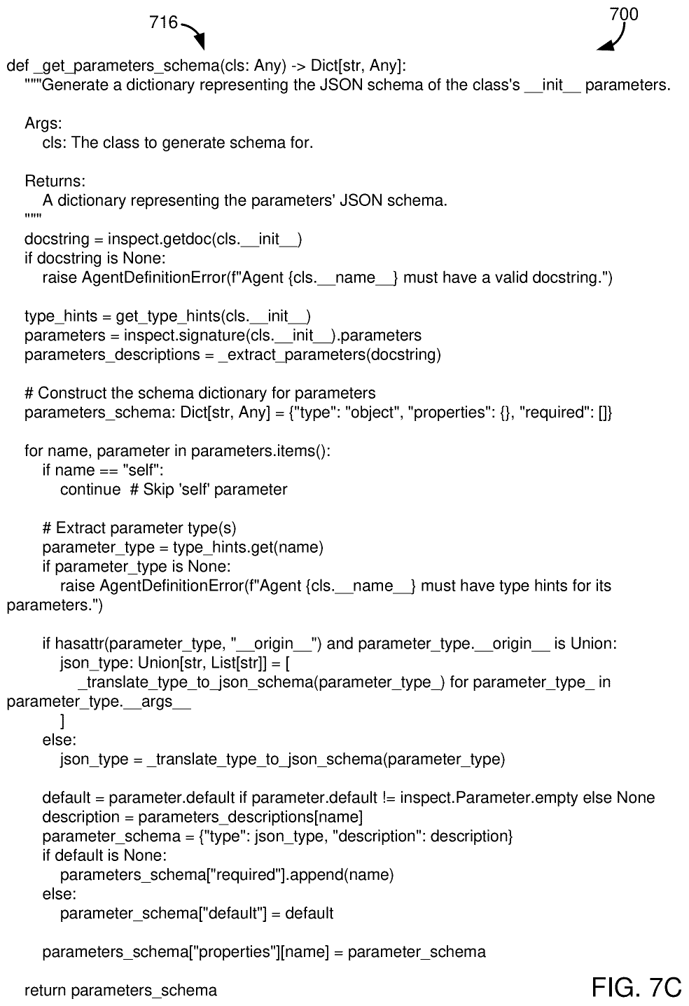

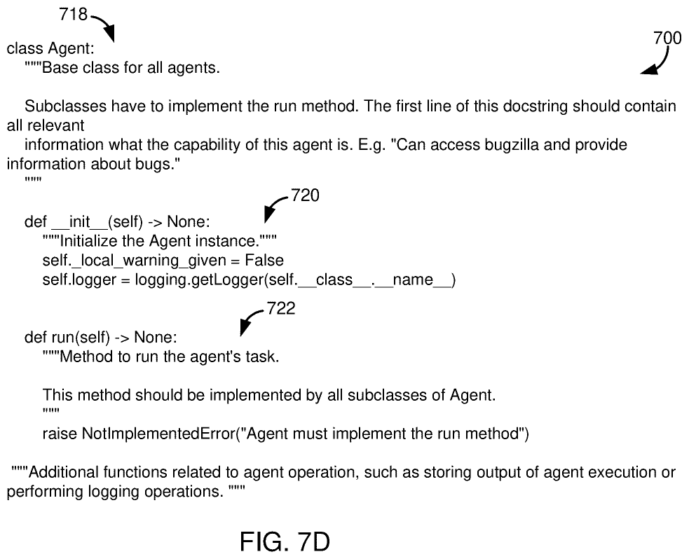

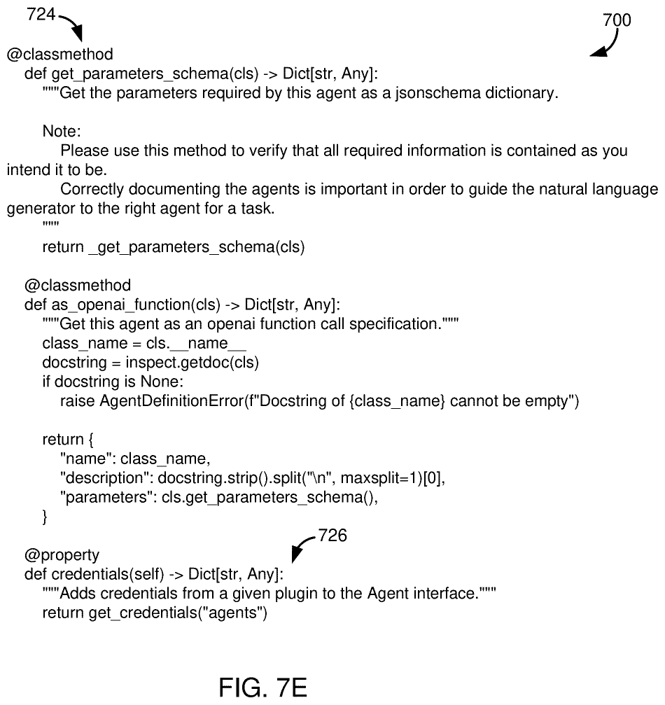

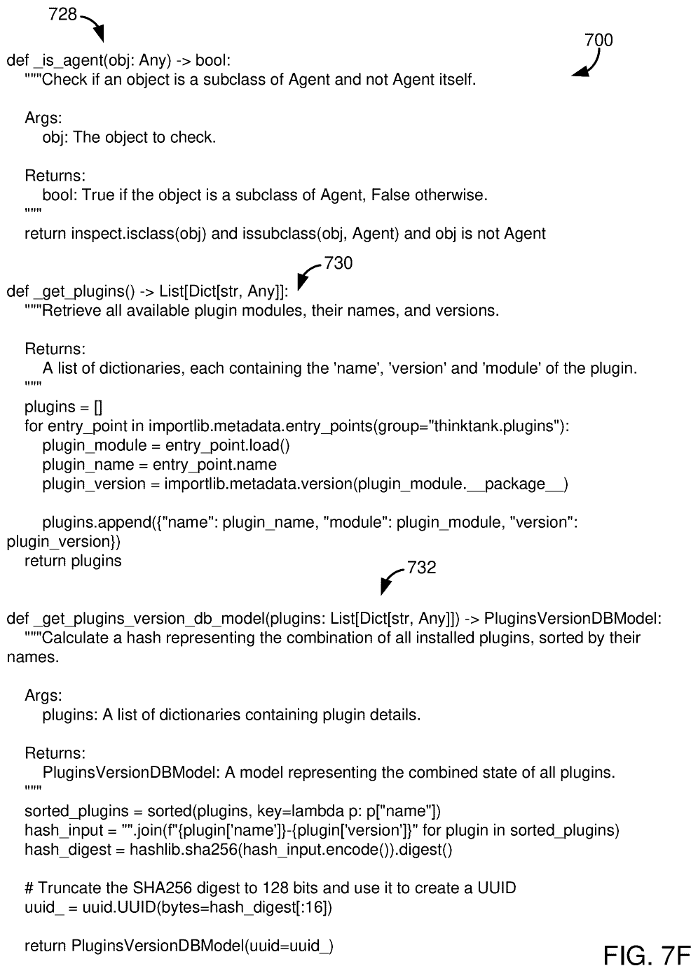

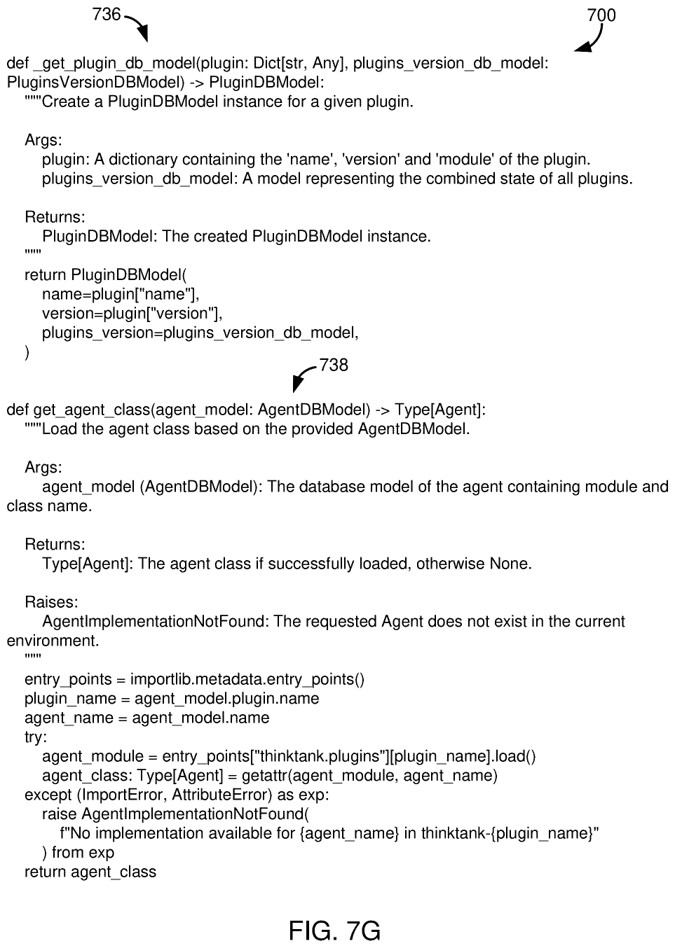

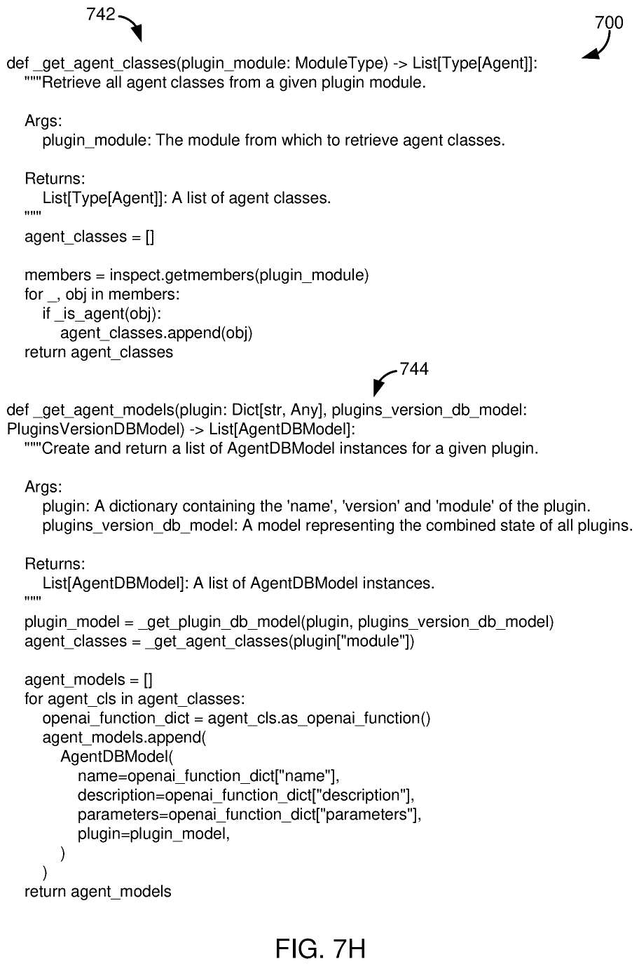

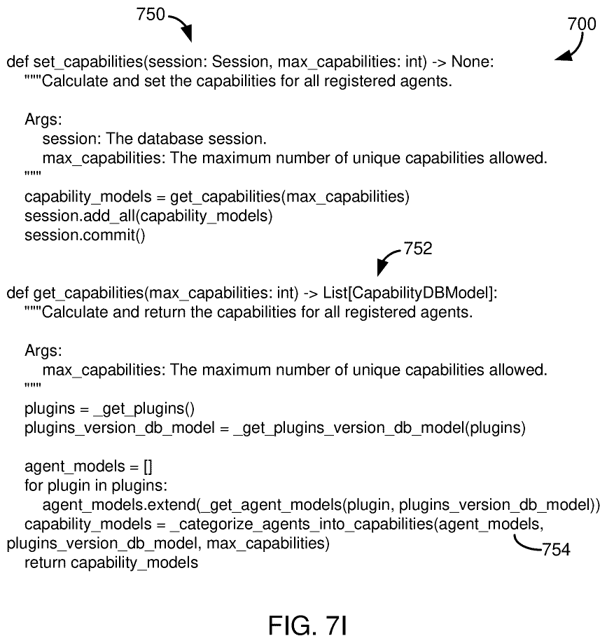

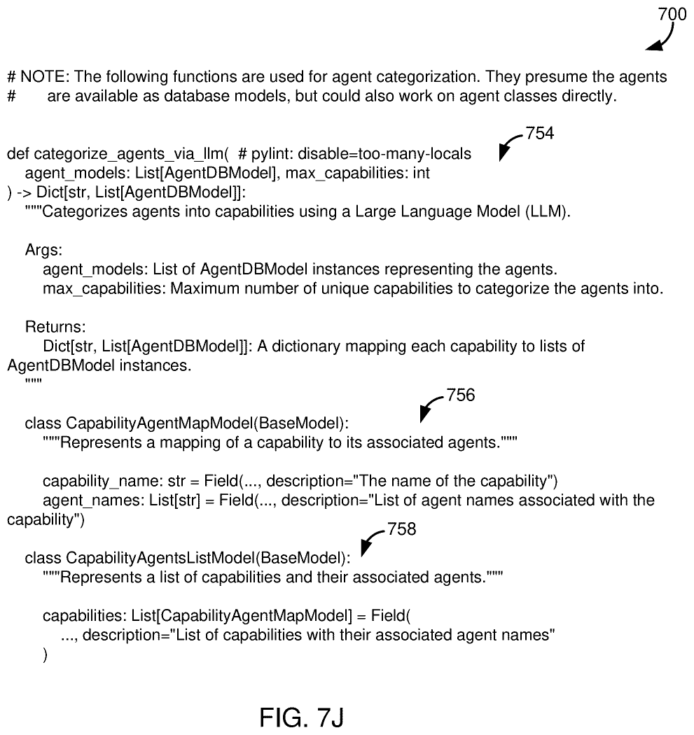

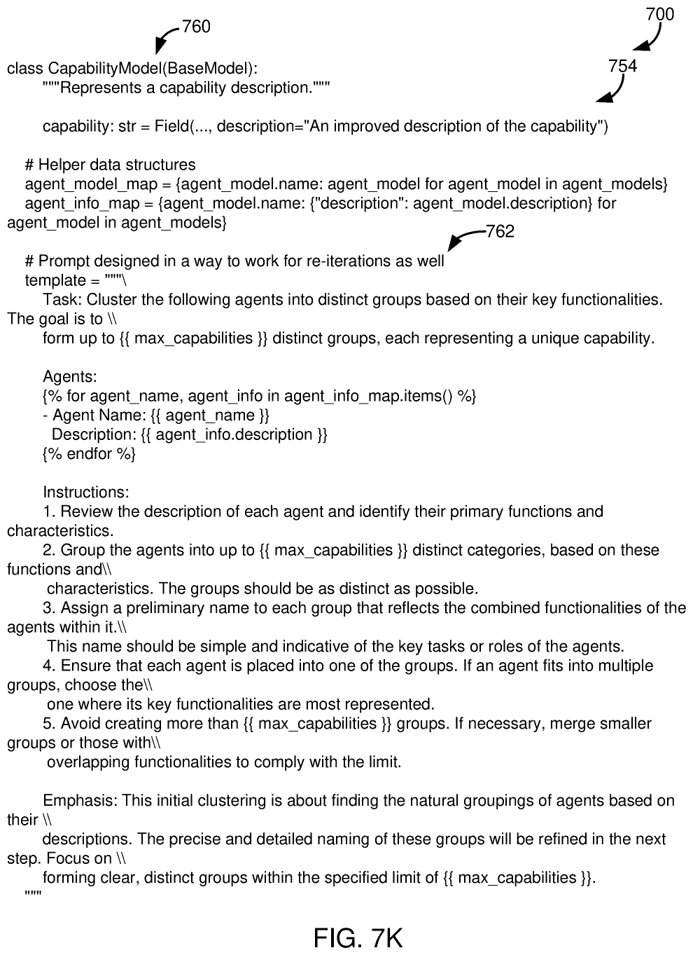

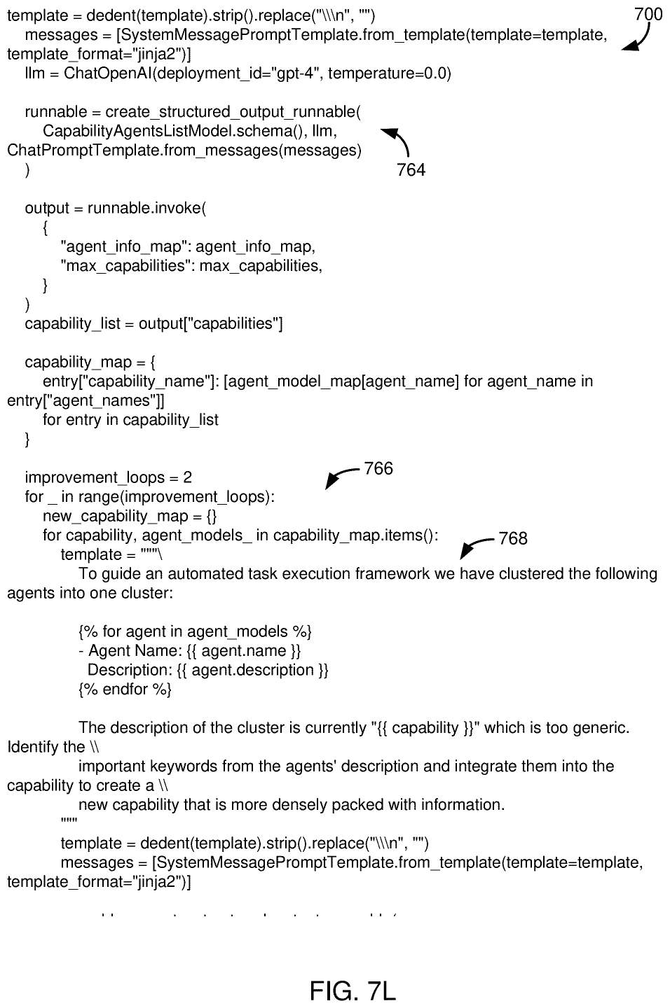

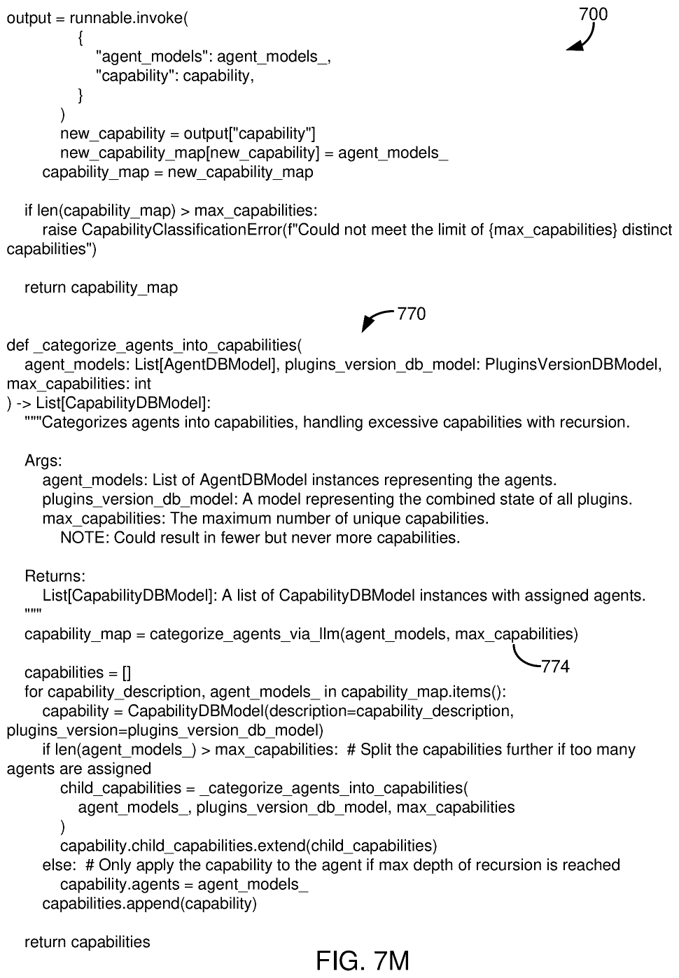

FIGS. 7A-7M illustrate example python code 700 for managing agents, such as agents defined using the code 600 of FIG. 6.

Referring first to FIG. 7A, line 702 imports various database information, including a database storing agent information and a database storing capabilities information (including hierarchical information). Lines 704 imports various exceptions that can be thrown, such as if an agent implementation or definition is not found, if there is an error with a parameter type provided for an agent, or if there is an error in classifying a capability.

As described, disclosed techniques can be implemented by analyzing data or metadata for agent definitions for use in classifying agents, or in calling such agents. Code 708 provides a function for extracting parameter names and descriptions from documentation information for code, such as information provided in a “docstring”.

It can be useful to convert code representations of agents, such as python code, into a standardized format, including in a format that can facilitate storage, search, and retrieval of agent information. Accordingly, in FIG. 7B, a function 712 is provided that analyzes python that may be included with variables used with agents and converts them to JSON schema types.

In FIG. 7C, a function 716 creates dictionary representations of parameters in the “initialization” function of an agent, converting python datatypes to JSON representations using the function 712 of FIG. 7B and using the extraction function 708 of FIG. 7A.

FIG. 7D provides a base agent class definition 718. The agents of the code 600 of FIG. 6 extends this base class, including providing implementations of an initialization function 720 and a “run” function 722. FIG. 7E provides a class method 724 for the base agent class 718 that obtains parameters for the particular agent in the form of a JSON schema dictionary. In some cases, the parameter information can be stored in another format, such as in a relational database, and retrieved and converted to the JSON format using the class method 724.

As another example of how agent information can be converted to different formats, a class method 724 obtains agent information and converts it to a form that is useable with a particular natural language generator, in this case a format used by OPENAI.

In order to execute, an agent may need particular credentials, such as security credentials. Code 726 defines a property that can be used to store such credentials.

In FIG. 7F, code 728 defines a function that checks whether an object instance is a subclass of the base agent class, and not an instance of the base agent class itself. This check can help avoid execution errors, since an instance of a base agent class may not have an implemented initialization function, parameters, or an implemented run function.

Disclosed techniques facilitate the development and use of agents. A central framework can be provided that, for example, identifies and manages agent execution, including performing classification of agents/providing structured representations of capabilities provided by the agents. The framework can also be responsible for interacting with a natural language generator, such as providing the natural language generator with information about capabilities, including providing information about capabilities at lower hierarchical levels in response to a selection of a capability at a higher level. The framework can also be responsible for executing agents and returning execution results to the natural language generator.

Code 730 of FIG. 7F defines a function for retrieving plugins. Although disclosed techniques are not limited to any particular plugin mechanism, plugin systems such as PLUGGY, HYPOTHESIS, DJANGO, and PYQT can be used. The function returns a list of dictionaries, where the dictionaries include information about agents provided by a given plugin.

It can be useful to track what plugins have been installed or processed for a framework, such as to determine whether a plugin has been added or removed, or if a version of a plugin has changed. Code 732 combines names and version information for individual plugins and from that calculates a hash value representing the current plugin library.

Turning to FIG. 7G, code 736 creates a dictionary for a single plugin, where the dictionary contains the name and version of the plugin, as well as the hash value calculated in code 732. Code 738 defines a function to load a particular agent using an agent database model provided as an argument. The argument provides the name of the agent class and information for locating the implementation of the agent class, such as the plugin module that defines the agent.

In FIG. 7H, code 742 retrieves all agents (agent classes) defined in a particular plugin, using the location information for the plugin module. Code 744 can be used for managing or monitoring particular agent instances. In particular, the code 744 takes a particular plugin as input, identifies the agents in the plugin, and then returns information, such as the name, description, and parameters, for instances for those agents that have been created.

Code 750 of FIG. 7I is associated with a processing of determining and classifying capabilities. In particular, code 750 sets a particular database session, containing agent information to be used, as well as a threshold to be used in organizing capabilities (as discussed in conjunction with FIGS. 3 and 5). Code 752 obtains agent information associated with plugins in the current database session and, at line 754, calls a function to begin the categorization process, providing the threshold as an argument.

In FIG. 7J, code 754 defines a function for categorizing agents into capabilities using a natural language generator. The function takes arguments of database representations of agents and the maximum number of capabilities to include at a particular hierarchical level. The function returns a dictionary that maps individual capabilities to particular agents. The code 754 defines classes 756, 758, which correspond to, respectively, the mapping of agents to capabilities and a list of capabilities and their associated agents.

Code 754 continues on FIG. 7K, where a class 760 is defined that represents a description of a capability. The class 760 includes an example prompt 762 that provides instructions to a natural language generator on how agent classification should be performed. In FIG. 7L, code 764 converts the example prompt 758 into a format to be submitted to the natural language generator, which is submitted to the natural language generator using code 770 of FIG. 7M.

It can be beneficial to revise the names of the capabilities after the initial categorization process by the natural language generator. For example, once all of the capabilities are known, the natural language generator may produce capabilities with more meaningful names, which can better guide selection of an appropriate capability, both in terms of making sure that different capabilities have descriptions that sufficiently different from each other, and being meaningful such that the description accurately and specifically conveys the nature of the capabilities. Code 766 of FIG. 7L defines a process of improving capabilities descriptions, which can be executed one or more times. Code 768 provides text for a specific prompt to a natural language generator such that the natural language generator can perform the improvement of the capability descriptions.

In FIG. 7M, code 770 defines a function to categorize agents into capabilities, which, a line 774, calls the function of code 754 of FIG. 7I. Note that, in this particular implementation, code 770 is responsible for creating new hierarchical levels if too many agents are assigned to a category after evaluation by the natural language generator using the prompt 770.

### Example 8—Example Operations

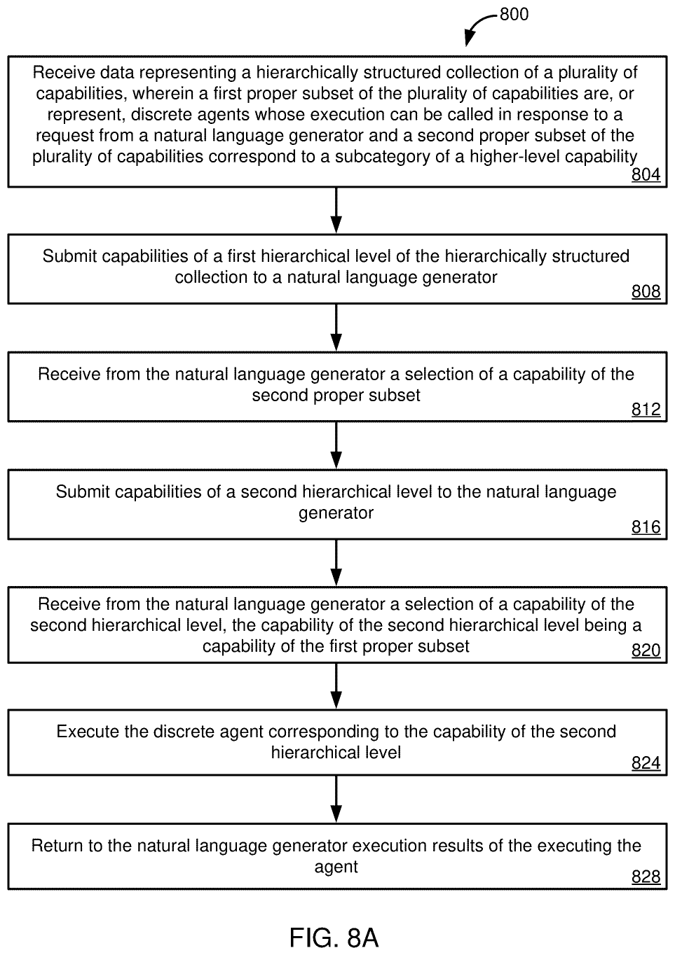

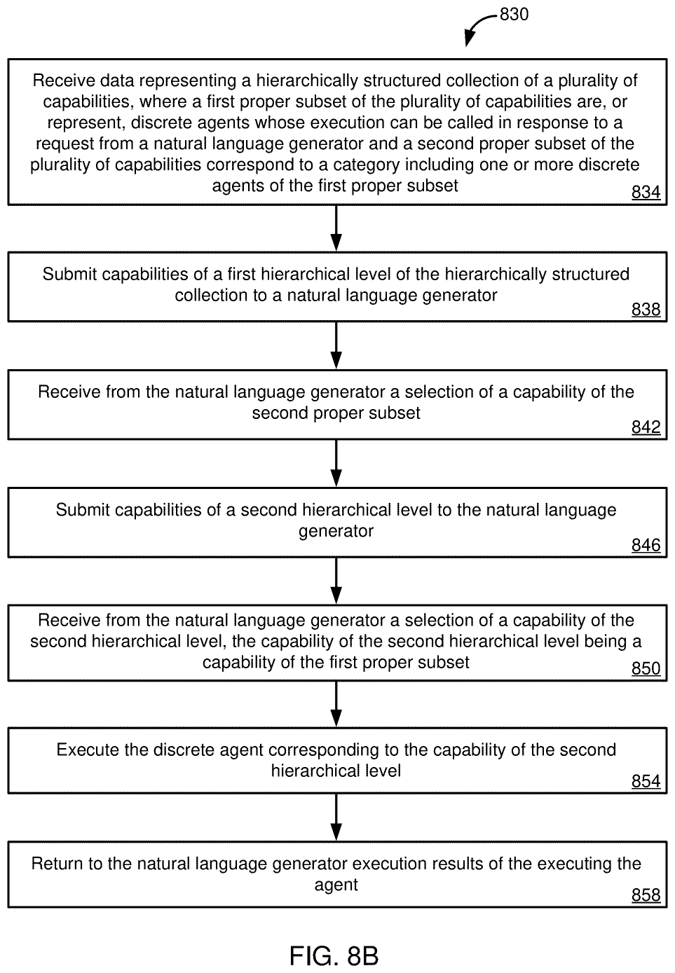

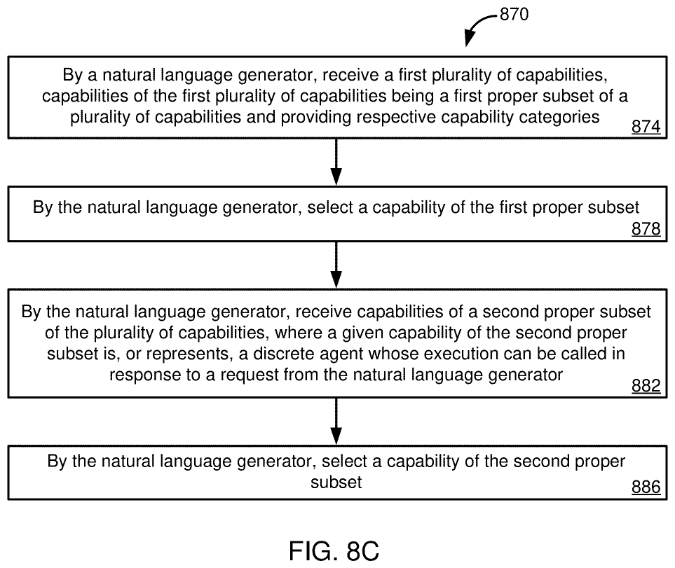

FIG. 8A is a flowchart of an example process 800 of progressively submitting subsets of a set of capabilities to a natural language generator. Data representing a hierarchically structured collection of a plurality of capabilities is received at 804. A first proper subset of the plurality of capabilities are, or represent, discrete agents whose execution can be called in response to a request from a natural language generator and a second proper subset of the plurality of capabilities correspond to a subcategory of a higher-level capability.

At 808, capabilities of a first hierarchical level of the hierarchically structured collection are submitted to a natural language generator. From the natural language generator, at 812, a selection of a capability of the second proper subset is received. Capabilities of a second hierarchical level are submitted to the natural language generator at 816. At 820, a selection of a capability of the second hierarchical level is received from the natural language generator. The capability of the second hierarchical level is a capability of the first proper subset. The discrete agent corresponding to the capability of the second hierarchical level is executed at 824. At 828, execution results of the executing the agent are returned to the natural language generator.

FIG. 8B is a flowchart of an example process 830 of progressively submitting subsets of a set of capabilities to a natural language generator. At 834, data representing a hierarchically structured collection of a plurality of capabilities is received. A first proper subset of the plurality of capabilities are, or represent, discrete agents whose execution can be called in response to a request from a natural language generator and a second proper subset of the plurality of capabilities correspond to a category comprising one or more discrete agents of the first proper subset.

Capabilities of a first hierarchical level of the hierarchically structured collection are submitted to a natural language generator at 838. At 842, a selection of a capability of the second proper subset is received from the natural language generator. Capabilities of a second hierarchical level are submitted to the natural language generator at 846. At 850, a selection of a capability of the second hierarchical level is received from the natural language generator. The capability of the second hierarchical level is a capability of the first proper subset. The discrete agent corresponding to the capability of the second hierarchical level is executed at 854. At 858, execution results of the executing the agent are returned to the natural language generator.

FIG. 8C is a flowchart of an example process 870 of a natural language generator selecting a capability for execution after being progressively presented with sets of capabilities. At 874, a natural language generator receives a first plurality of capabilities. Capabilities of the first second proper subset of the plurality of capabilities provide respective capability categories. The natural language generator selects a capability of the first proper subset at 878. At 882, the natural language generator receives capabilities of a second proper subset of the plurality of capabilities. A given capability of the second proper subset is, or represents, a discrete agent whose execution can be called in response to a request from the natural language generator. The natural language generator selects a capability of the second proper subset at 886.

### Example 9—Additional Examples

Example 1 includes a computing system comprising at least one memory and one or more hardware processor units coupled to the at least one memory. The computing system also includes one or more computer-readable storage media storing computer-executable instructions that, when executed, cause the computing system to perform operations. These operations include receiving data representing a hierarchically structured collection of a plurality of capabilities, where a first proper subset of the plurality of capabilities are, or represent, discrete agents whose execution can be called in response to a request from a natural language generator, and a second proper subset of the plurality of capabilities corresponds to a subcategory of a higher-level capability. The operations also include submitting capabilities of a first hierarchical level to a natural language generator, receiving from the natural language generator a selection of a capability of the second proper subset, submitting capabilities of a second hierarchical level to the natural language generator, receiving from the natural language generator a selection of a capability of the second hierarchical level, the capability of the second hierarchical level being a capability of the first proper subset, executing the discrete agent corresponding to the capability of the second hierarchical level, and returning to the natural language generator execution results of the executing the agent.

Example 2 includes the subject matter of Example 1. The computing system also includes operations for generating the hierarchically structured collection. The generation includes classifying a first plurality of agents into a first number of categories not exceeding a first threshold defined for the first hierarchical level; for at least one category of the first number of categories, determining that a number of agents classified in the at least one category exceeds a second threshold defined for at least the second hierarchical level, where the second threshold is the first threshold or is different than the first threshold; and in response to determining that a number of agents classified in the at least one category exceeds the second threshold, classifying a second plurality of agents into a second number of categories not exceeding a second threshold defined for the second hierarchical level.

Example 3 includes the subject matter of Example 1 or Example 2. The operations of classifying the first plurality of agents and the classifying the second plurality of agents are performed by a natural language generator.

Example 4 includes the subject matter of Example 3. The operations also include submitting descriptive information for the first plurality of agents to the natural language generator in a prompt providing instructions for performing a classification process.

Example 5 includes the subject matter of Example 4. The operations also include determining agents registered in an agent repository and extracting the descriptive information for the agents from the agent repository.

Example 7 includes the subject matter of Example 6. The operations also include submitting the first descriptive information and the second descriptive information to the natural language generator with a prompt comprising an instruction to revise the first descriptive information and the second descriptive information.

Example 8 includes the subject matter of any of Examples 1-7. In this example, the discrete agents are computing language subclasses of a computing language agent base class.

Example 9 includes the subject matter of any of Examples 1-8. In this example, the discrete agents are defined in one or more plugins registered with an agent framework.

Example 10 includes the subject matter of Example 9. The operations include registering at least one plugin of the one or more plugins with the agent framework and extracting descriptive information for the discrete agent from the at least one plugin.

Example 11 includes the subject matter of Example 10. The operations also include, for respective agents of the at least one plugin, storing in a database an identifier of a respective agent and at least a portion of the descriptive information for the respective agent.

Example 12 includes the subject matter of any of Examples 1-11. The operations include receiving a prompt to be submitted to the natural language generator and adding to the prompt the capabilities of the first hierarchical level to provide a revised prompt; where the submitting capabilities of the first hierarchical level to the natural language generator includes submitting the revised prompt to the natural language generator.

Example 13 includes the subject matter of any of Examples 1-12. The hierarchically structured collection is stored in one or more tables of a database comprising information for capabilities of the hierarchical structure. The information includes, for respective capabilities of the capabilities, at least one attribute comprising descriptive information for the capability and a reference to at least one other capability of the capabilities corresponding to a parent capability or a child capability.

Example 14 includes the subject matter of Example 13. At least one table of the one or more tables includes an attribute indicating whether a respective capability corresponds to an agent.

Example 15 includes the subject matter of Example 13. At least one table of the one or more tables includes an attribute identifying, for capabilities corresponding to agents, an identifier of an agent corresponding to the capability.

Example 16 is a method, implemented in a computing system comprising at least one memory and at least one hardware processor coupled to the at least one memory. The method includes receiving data representing a hierarchically structured collection of a plurality of capabilities, where a first proper subset of the plurality of capabilities are, or represent, discrete agents whose execution can be called in response to a request from a natural language generator and a second proper subset of the plurality of capabilities corresponds to a subcategory comprising one or more discrete agents of the first proper subset. The method also includes submitting capabilities of a first hierarchical level to a natural language generator, receiving from the natural language generator a selection of a capability of the second proper subset, submitting capabilities of a second hierarchical level to the natural language generator, receiving from the natural language generator a selection of a capability of the second hierarchical level, the capability of the second hierarchical level being a capability of the first proper subset, executing the discrete agent corresponding to the capability of the second hierarchical level, and returning to the natural language generator execution results of the executing the agent.

Example 17 includes the subject matter of Example 16. The method further includes generating the hierarchically structured collection, the generating comprising: classifying a first plurality of agents of the first proper subset into a first number of categories not exceeding a first threshold defined for the first hierarchical level; for at least one category of the first number of categories, determining that a number of agents of the first proper subset classified in the at least one category exceeds a second threshold defined for at least the second hierarchical level, where the second threshold is the first threshold or is different than the first threshold; and in response to determining that a number of agents of the first proper subset classified in the at least one category exceeds a second threshold, classifying a second plurality of agents of the first proper subset into a second number of categories not exceeding a second threshold defined for the second hierarchical level.

Example 18 includes the subject matter of Example 16 or Example 17. In this example, the discrete agents of the first proper subset are computing language subclasses of a computing language agent base class.

Example 19 is one or more computer-readable storage media comprising computer-executable instructions that, when executed by a computing system comprising at least one memory and at least one hardware processor coupled to the at least one memory, cause the computing system to, by a natural language generator, receive a first plurality of capabilities, capabilities of the first plurality of capabilities being a first proper subset of a plurality of capabilities and providing respective capability categories. The instructions also cause the computing system to, by the natural language generator, select a capability of the first proper subset; receive capabilities of a second proper subset of the plurality of capabilities, where a given capability of the second proper subset is, or represents, a discrete agent whose execution can be called in response to a request from the natural language generator; and by the natural language generator, select a capability of the second proper subset.

Example 20 includes the subject matter of Example 19. The computer-readable storage media further comprise computer-executable instructions that, when executed by the computing system, cause the computing system to return to the natural language generator execution results of executing an agent corresponding to the capability of the second proper subset selected by the natural language generator.

### Example 10—Computing Systems

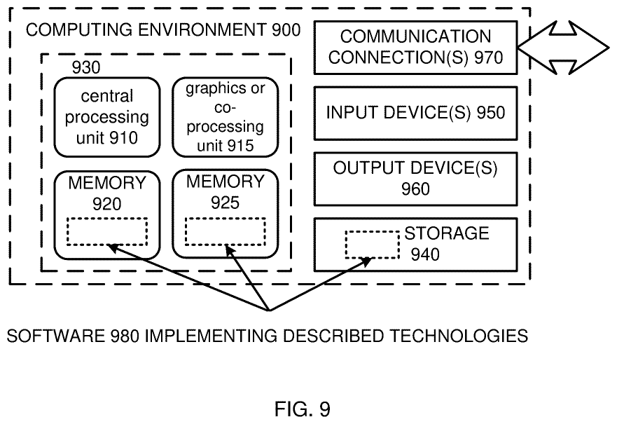

FIG. 9 depicts a generalized example of a suitable computing system 900 in which the described innovations may be implemented. The computing system 900 is not intended to suggest any limitation as to scope of use or functionality of the present disclosure, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions, such as for implementing a database environment, and associated methods, described in Examples 1-9. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s) 910, 915. The memory 920, 925 stores software 980 implementing one or more innovations described herein, in the form of computer-executable instructions suitable for execution by the processing unit(s) 910, 915.

A computing system 900 may have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information in a non-transitory way, and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. The output device(s) 960 may be a display, printer, speaker, CD-writer, or another device that provides output from the computing system 900.

The communication connection(s) 970 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 11—Cloud Computing Environment

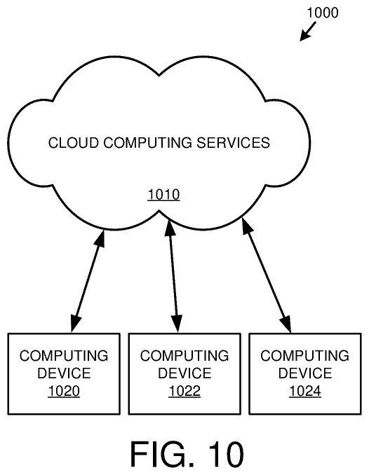

FIG. 10 depicts an example cloud computing environment 1000 in which the described technologies can be implemented. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operators (e.g., data processing, data storage, and the like).

### Example 12—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 11, computer-readable storage media include memory 1120 and 1125, and storage 1140. The term computer-readable storage media does not include signals and carrier waves. In addition, the term computer-readable storage media does not include communication connections (e.g., 1170).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
receiving data representing a hierarchically structured collection of a plurality of capabilities, wherein a first proper subset of the plurality of capabilities are, or represent, discrete agents whose execution can be called in response to a request from a natural language generator and a second proper subset of the plurality of capabilities correspond to a subcategory of a higher-level capability;
submitting capabilities of a first hierarchical level of the hierarchically structured collection to a natural language generator;
receiving from the natural language generator a selection of a capability of the second proper subset;
submitting capabilities of a second hierarchical level to the natural language generator;
receiving from the natural language generator a selection of a capability of the second hierarchical level, the capability of the second hierarchical level being a capability of the first proper subset;
executing the discrete agent corresponding to the capability of the second hierarchical level; and
returning to the natural language generator execution results of the executing the agent.

2. The computing system of claim 1, the operations further comprising:
generating the hierarchically structured collection, the generating comprising:
classifying a first plurality of agents into a first number of categories not exceeding a first threshold defined for the first hierarchical level;
for at least one category of the first number of categories, determining that a number of agents classified in the at least one category exceeds a second threshold defined for at least the second hierarchical level, wherein the second threshold is the first threshold or is different than the first threshold; and
in response to determining that a number of agents classified in the at least one category exceeds a second threshold, classifying a second plurality of agents into a second number of categories not exceeding a second threshold defined for the second hierarchical level.

3. The computing system of claim 2, wherein the classifying the first plurality of agents and the classifying the second plurality of agents are performed by a natural language generator.

4. The computing system of claim 3, wherein descriptive information for the first plurality of agents is submitted to the natural language generator in a prompt providing instructions for performing a classification process.

5. The computing system of claim 4, the operations further comprising:
determining agents registered in an agent repository; and
extracting the descriptive information for the agents from the agent repository.

6. The computing system of claim 3, wherein the natural language generator generates first descriptive information for the first hierarchical level and second descriptive information for the second hierarchical level.

7. The computing system of claim 6, the operations further comprising:
submitting the first descriptive information and the second descriptive information to the natural language generator with a prompt comprising an instruction to revise the first descriptive information and the second descriptive information.

8. The computing system of claim 1, wherein the discrete agents are computing language subclasses of a computing language agent base class.

9. The computing system of claim 1, wherein the discrete agents are defined in one or more plugins registered with an agent framework.

10. The computing system of claim 9, the operations further comprising:
registering at least one plugin of the one or more plugins with the agent framework; and
extracting descriptive information for the discrete agent from the at least one plugin.

11. The computing system of claim 10, the operations further comprising:
for respective agents of the of at least one plugin, storing in a database an identifier of a respective agent and at least a portion of the descriptive information for the respective agent.

12. The computing system of claim 1, the operations further comprising:
receiving a prompt to be submitted to the natural language generator; and
adding to the prompt the capabilities of the first hierarchical level to provide a revised prompt;
wherein the submitting capabilities of the first hierarchical level to the natural language generator comprises submitting the revised prompt to the natural language generator.

13. The computing system of claim 1, wherein the hierarchically structured collection is stored in one or more tables of a database comprising information for capabilities of the hierarchical structure, the information comprising, for respective capabilities of the capabilities, at least one attribute comprising descriptive information for the capability and a reference to at least one other capability of the capabilities corresponding to a parent capability or a child capability.

14. The computing system of claim 13, wherein at least one table of the one or more tables comprises an attribute indicating whether a respective capability corresponds to an agent.

15. The computing system of claim 13, wherein at least one table of the or more tables comprises an attribute identifying, for capabilities corresponding to agents, an identifier of an agent corresponding to the capability.

16. A method, implemented in a computing system comprising at least one memory and at least one hardware processor coupled to the at least one memory, the method comprising:
receiving data representing a hierarchically structured collection of a plurality of capabilities, wherein a first proper subset of the plurality of capabilities are, or represent, discrete agents whose execution can be called in response to a request from a natural language generator and a second proper subset of the plurality of capabilities correspond to a category comprising one or more discrete agents of the first proper subset;
submitting capabilities of a first hierarchical level of the hierarchically structured collection to a natural language generator;
receiving from the natural language generator a selection of a capability of the second proper subset;
submitting capabilities of a second hierarchical level to the natural language generator;
receiving from the natural language generator a selection of a capability of the second hierarchical level, the capability of the second hierarchical level being a capability of the first proper subset;
executing the discrete agent corresponding to the capability of the second hierarchical level; and
returning to the natural language generator execution results of the executing the agent.

17. The method of claim 16, further comprising:
generating the hierarchically structured collection, the generating comprising:
classifying a first plurality of agents of the first proper subset into a first number of categories not exceeding a first threshold defined for the first hierarchical level;
for at least one category of the first number of categories, determining that a number of agents of the first proper subset classified in the at least one category exceeds a second threshold defined for at least the second hierarchical level, wherein the second threshold is the first threshold or is different than the first threshold; and
in response to determining that a number of agents of the first proper subset classified in the at least one category exceeds a second threshold, classifying a second plurality of agents of the first proper subset into a second number of categories not exceeding a second threshold defined for the second hierarchical level.

18. The method of claim 16, wherein the discrete agents of the first proper subset are computing language subclasses of a computing language agent base class.

19. One or more computer-readable storage media comprising:
computer-executable instructions that, when executed by a computing system comprising at least one memory and at least one hardware processor coupled to the at least one memory, cause the computing system to, by a natural language generator, receive a first plurality of capabilities, capabilities of the first plurality of capabilities being a first proper subset of a plurality of capabilities and providing respective capability categories;
computer-executable instructions that, when executed by the computing system, cause the computing system to, by the natural language generator, select a capability of the first proper subset;
computer-executable instructions that, when executed by the computing system, cause the computing system to, by the natural language generator, receiving capabilities of a second proper subset of the plurality of capabilities, wherein a given capability of the second proper subset is, or represents, a discrete agent whose execution can be called in response to a request from the natural language generator;
computer-executable instructions that, when executed by the computing system, cause the computing system to, by the natural language generator, select a capability of the second proper subset.

20. The one or more computer-readable storage media of claim 19, further comprising:
computer-executable instructions that, when executed by the computing system, cause the computing system to return to the natural language generator execution results of executing an agent corresponding to the capability of the second proper subset selected by the natural language generator.
